(19) United States
(12) Patent Application Publication
(10) Pub. No.: US 2015/0213666 A1
(43) Pub. Date: Jul. 30, 2015

(54) Verification of Documents of Value Having a Window Displaying Diffractive Structures

(71) Applicant: GIESECKE & DEVRIENT GMBH, München (DE)

(72) Inventors: Peter Schiffmann, Munich (DE); Christian Fuhse, Otterfing (DE)

(73) Assignee: GIESECKE & DEVRIENT GMBH, München (DE)

(21) Appl. No.: 14/403,662

(22) PCT Filed: May 27, 2013
(86) PCT No.: PCT/EP2013/001563

§ 371 Date: Nov. 25, 2014

(30) Foreign Application Priority Data
Jun. 1, 2012 (DE) 10 2012 010 908.3

(51) Int. Cl. G07D 7/20; B42D 25/351

(52) U.S. Cl. CPC G07D 7/2016; B42D 25/351

(57) ABSTRACT

An apparatus and method for verifying value documents involves a substrate having at least one light-transmissive region with a first information item. A separate display comprises a gridded arrangement of pixels and a second information item is displayed through the separate display at least regionally to correlate with the first information item. A further information item not recognizable and/or readable to a viewer without auxiliary means is hidden in the first and/or second information item. The substrate is placed with its first information item over the second information item which is displayed on the separate display, and the hidden information item becomes recognizable and/or readable. The first information item is formed by light-transmissive diffractive structures whose surface is furnished with an at least partly reflective coating formed from elements arranged in a gridded manner.

This invention relates to a method and apparatus for verifying value documents, such as for example bank notes, papers of value, credit cards, debit cards or identification cards, passports, deeds, admission tickets, lottery tickets and the like, labels, packages, fiscal stamps, cigarette pull strips or other elements for product authentication or marketing campaigns. At least one light-transmissive region of a security element has a first information item arranged therein. A separate display, for example a screen of a computer, notebook or laptop, a monitor of a cash register of a cash-register system, or a display of a hand-held unit, displays at least regionally a second information item. Either the first or the second information item or else both information items have a further information item hidden therein which is not, or hardly, recognizable and/or readable to a viewer without auxiliary means. A verification of the security element is effected by the first information item in the translucent region of the security element being placed over the second information item and the hidden information item becoming recognizable and/or readable. The invention relates further to a corresponding method for verifying or testing objects of value having a display, for example a computer, notebook or laptop, a cash register of a cash-register system, a television set or a hand-held unit.

A generic method is known from WO 2009/019038 A1. Here, the hidden information item advantageously involves for example the emission value or the currency of a bank note and can thus serve as an authenticity test on a point-of-sale terminal. The bank note is placed over the display of the point-of-sale terminal and the information item hidden on the bank note becomes visible to the checkout clerk in plaintext.

From WO 2009/019038 A1 it is known that a moiré pattern results when a grid consisting of scattering elements from blind embossings or optical lenses is applied to the light-transmissive region of the security element or of the verification element and a micro-information item coordinated with the scattering elements is represented on the display. Through the superimposition with the grid consisting of scattering elements the micro-information item is represented magnified many times, but must be adapted to the grid of the security element or of the verification element.

Furthermore, the indirect letterpress printing known from the prior art usually allows a minimum line width of 40 μm for positive lines and 80 μm for negative lines in connection with the substrate to be printed. In this connection a positive line is a printed line-shaped region that is formed by a printing ink, while a negative line is a blank line-shaped region without printing ink in a region printed over the full area or in a grid-shaped manner. With offset printing, a minimum line width of 30 μm can be obtained for positive lines, and a minimum line width of 50 μm for negative lines. However, it must be taken into consideration here that, due to slip, the rheology of the ink and the capillary forces in the substrate (color fringe, flow to the edge), the printing process gives rise to an increase in line width which can amount to approx. 5 μm on each side of the line. This increases the actual line width for example to 40 μm for positive lines in offset printing and to 50 μm in indirect letterpress printing.

For the displays of mobile telephones, smartphones, television sets and other devices there is a trend toward extremely high resolutions, i.e. an especially high number of pixels per unit area. The prior art includes so-called active-matrix displays, in which a liquid-crystal screen consists of a matrix of image points, the so-called display matrix, with each individual image point possessing an active amplifier and power-supply connections. The individual pixels of the display matrix can no longer be recognized by a viewer with the unarmed eye, but only by means of a microscope. For example, the so-called retina display of the current smartphone “iphone 4” from the company Apple® has a resolution of 960×640 pixels at a screen diagonal of 8.9 cm, and the so-called AMOLED display of the smartphone “Galaxy S I9000” from the company Samsung® has a resolution of 480×800 pixels at a screen diagonal of 10.2 cm.

Such a high resolution can currently not be obtained by printing methods known from the prior art, or only with high reject rates, at the expense of the contrast or with a loss of picture information.

The invention is therefore based on the object of developing a generic security element so as to eliminate the disadvantages of the prior art and further increase the protection from forgeries.

This object is achieved by the features of the independent claims. Developments of the invention are the subject matter of the dependent claims.

According to the invention, the first information item is formed by light-transmissive diffractive structures whose surface is furnished with an at least partly reflective coating. The at least partly reflective coating is formed here from elements arranged in a gridded manner, with the gridded arrangement of said elements being adapted to the gridded arrangement of the pixels of the display.

The elements of the at least partly reflective coating that are arranged in a gridded manner can be produced in the necessary resolution in order to thereby produce a grid that is coordinated with the display matrix of high-resolution displays or is also adaptable to even higher-resolution future displays.

Diffractive structures as intended by this invention are grating-like structures on which incident light is diffracted. The grating-like structure can be executed for example in the form of a line grating or cross grating. The dimensions of the grating-like structures lie in the range of the wavelength of the incident light, with the dimensions lying below the wavelength of the incident light in so-called zero-order diffraction gratings or devices (ZODs).

Particularly preferably, the diffractive structures are formed by at least one surface-structure hologram. A surface-structure hologram or surface-structure grating is manufactured particularly preferably by embossing or exposing a lacquer layer or photoresist layer which is applied to the substrate, the exposure being effected by means of electromagnetic radiation or with electron beams. The depth of the produced structures is lower than the light wavelength, the hill and valley structures having the order of magnitude of the light wavelength. The structured surface is mirror-coated when the hologram or grating image is to be used in reflection.

Light-transmissive or translucent as intended by this invention means that an object passes a certain share of impinging light therethrough. When light impinges on one side of the object, a certain share of the light is passed through to the other side of the object and exits there again. The greater the percentage share of the light passing through is relative to the impinging light, the more light-transmissive or translucent the object is. If the percentage share is at least 90%, i.e. the object passes the impinging light nearly unattenuated therethrough like a window, the object is designated as transparent. An object passing between 90% and 20% of the impinging light therethrough is designated as partly transparent. However, an object passing less than 20%, preferably less than 10% and particularly preferably about 0%, of the impinging light therethrough, i.e. in which the share of light passing therethrough relative to the impinging light is low or near or equal to zero, is designated as opaque or as non-light-transmissive.

An at least partly reflective coating as intended by this invention is a coating whose surface throws back at least a portion of the electromagnetic radiation impinging on the surface of the coating. Said electromagnetic radiation is in particular light. Particularly preferably there occurs directional or specular reflection causing a metallic appearance, but diffusely reflective surfaces causing a rather matt appearance are also possible. The share of electromagnetic radiation that is not reflected by the surface enters the coating and is dissipated and/or transmitted there. Preferably, the dissipated and/or transmitted share of electromagnetic radiation is smaller than the reflected share. Particularly preferably, the dissipated and/or transmitted share of electromagnetic radiation is nearly zero, so that the surface of the coating reflects the impinging electromagnetic radiation nearly completely.

An information item as intended by this invention is an alphanumeric text, a symbol or an arbitrary graphic whose information content can be optically perceived and interpreted by a viewer. Furthermore, the information item can also be the content of a message for the viewer which is assembled from characters of a code, according to the definition from the field of cybernetics. For example, the information item can be a [symbol] or $ symbol, a statement of value, a graphic in the form of an eagle, or a bar code.

A pixel as intended by this invention is understood to be an individual image point of the display. For example, in a black-and-white display a pixel represents a light/dark contrast, by the pixel passing or not passing therethrough light of a background illumination for example. In a color display a pixel consists of an individual colored image point, for example a red image point, which passes or does not pass therethrough only the red spectral portion of the background illumination of the display, like a color filter. A combination of differently colored pixels, for example red, green and blue pixels, gives rise to the chromaticity of the display. An arrangement consisting of a red, a green and a blue pixel is designated as an RGB sequence according to this invention.

For example, the display of the smartphone “Galaxy S I9000” from the company Samsung® has rectangular or square pixels which as an RGB sequence consist of a red, green and blue pixel, with a multiplicity of such RGB sequences being arranged alternatingly beside and above each other in rows and columns. This results in an x-y matrix, consisting of a multiplicity of RGB sequences, with no two like-colored pixels bordering on or abutting each other at any place. With the resolution or number of 480×800 pixels and a screen diagonal of 10.2 cm, each individual pixel consequently requires an, on average, square area with an averaged edge length of about 0.1 mm.

According to a further preferred embodiment, the at least partly reflective coating is applied to the substrate over the full area at least in partial regions of the substrate, and the gridded arrangement of the elements is produced by gridded ablation of the coating. Particularly preferably, the ablation of the coating is effected using a laser beam or a washing method. A corresponding washing method is known for example from EP 1023499 A1 or EP 1520929 A1. The advantage of ablation using a laser is that the value document can be individualized later, or the first information item incorporated into the reflective coating later.

Alternatively, the at least partly reflective coating is applied to the substrate in a gridded manner at least in partial regions of the substrate. A later individualization as in the above-described method is likewise possible.

According to a further preferred embodiment, the at least partly reflective coating is imprinted by known printing methods. Particularly preferably, the at least partly reflective coating is formed here by an ink containing metallic or metalloid pigments.

Alternatively, the at least partly reflective coating can be vapor-deposited, the materials vapor-deposited preferably being metallic, metalloid or metallic in appearance. Vapor-depositing is preferably effected by known methods, such as for example by physical vapor deposition (PVD) or chemical vapor deposition (CVD).

Particularly preferably, the gridded arrangement of elements of the at least partly reflective coating is adapted to the gridded arrangement of pixels of the display such that the elements have the same dimensions as the pixels of the display and are arranged in the same grid. In terms of the example of the smartphone “Galaxy S I9000” from the company Samsung®, the microstructures would thus have a substantially square area with an edge length of about 0.1 mm and would be arranged beside or above each other in a matrixed manner in rows and columns.

Neither the pixels of the display nor the elements of the at least partly reflective coating must have a square shape, of course. Rather, any shape is possible, for example rectangular, circular or triangular. Also, neither the pixels of the display nor the elements of the at least partly reflective coating must be arranged in a rectangular n×m matrix. Rather, any gridded arrangement is possible, for example a parallelogram-type matrix or an arbitrary offset from line to line of a matrix.

For example, an RGB sequence can also consist of five pixels. One pixel of a certain color, for example the blue pixel, is arranged here in the middle of the RGB sequence resting on a corner, one red pixel on the upper left side and one red pixel on the lower right side of the blue pixel, and one green pixel on the lower left side and one green pixel on the upper right side thereof.

Furthermore, the order of the pixels within an RGB sequence can be changed in one line compared with the corresponding order of an adjacent line. For example, an RGB sequence can consist of a red pixel beside a blue pixel beside a green pixel in one line, and of a green pixel beside a blue pixel beside a red pixel in the following line. The blue pixels of both lines thus border on each other, while the red and green pixels alternate from line to line.

A security element and/or verification element is especially advantageously produced that requires very high technical and financial effort for imitation by a forger on account of its complexity and can simultaneously also be used by a layman easily and without any deep technical understanding.

A display, i.e. a display device that can alternately represent different information items or else no information, is preferably an active display having a dedicated illumination source which illuminates the display from the back. Likewise, the display can also be a passive display without a dedicated illumination source, with a mirroring area arranged on the back of the display reflecting daylight or room light and indirectly illuminating the display therewith. The invention is preferably also applicable on a novel transparent display whose base body is perceived by a viewer as (nearly) transparent. The transparent display acts here basically as a (nearly) transparent window and the information items represented on the transparent display are represented as single- or multicolored opacifications of the window which influence or attenuate the light passing through the transparent display. Likewise, the invention is preferably employable on a self-luminous display in which the pixels themselves glow, so that neither daylight or room light nor a back-side light source is required.

The hand-held unit is for example a mobile telephone or smartphone, a digital camera, a digital watch, a credit card or an identity document, for example a passport or an identification card, having a display, or a portable player for video signals or audio signals.

An information item is always unrecognizable or hardly recognizable according to the invention when a viewer cannot see or perceive it, or only randomly and indistinctly, out of the surrounding information without auxiliary means. In the same way, an information item is always unreadable or hardly readable when a viewer cannot see or read, or only randomly and indistinctly, or cannot correctly interpret, the alphanumeric or textual content of the information out of the surrounding information without auxiliary means.

If the display has a higher resolution than the gridded arrangement of the elements of the at least partly reflective coating of the verification element, a grid with a reduced resolution can be displayed on the display, according to a further preferred embodiment, the reduced resolution being adapted to the resolution of the gridded arrangement of the elements of the at least partly reflective coating of the verification element. For example, colored lines whose line spacing corresponds to the spacing of adjacent elements of the verification element can be displayed on the display.

According to a further preferred embodiment, the first information item has at least a third information item contained therein. The third information item covers only a partial region of the surface of the first information item, so that the viewer can recognize both the hidden information item and the second information item.

The third information item is preferably recognizable and/or readable to the viewer in the visible wavelength region without auxiliary means. Alternatively, the third information item can also not be visible to a viewer in the visible wavelength region by being recognizable for example in the ultraviolet or infrared wavelength region. Alternatively, the third information item can also be visible or recognizable to a viewer both in the visible and in the non-visible wavelength region, by being recognizable for example in the visible and also in the ultraviolet or infrared wavelength region. Visible means here that a viewer can optically perceive an information item without auxiliary means, while recognizable means that a viewer can perceive an information item only using auxiliary means, for example using measuring instruments.

Said third information item can constitute an alphanumeric text, a symbol or an arbitrary graphic and be applied to the upper side or underside of the light-transmissive region of the substrate where the first information item is located. Application can preferably be effected using printing methods, for example imprinting opaque or glazing inks by offset printing, or using vapor deposition with the above-mentioned PVD or CVD.

Furthermore, a layer can be applied to the upper side or underside of the light-transmissive region, with the third information item being produced by partially ablating said layer. This is effected for example by removing a part of the layer again using a washing method known from the prior art (as known for example from EP 1 023 499 A1), using laser ablation or using mechanical methods (for example planing).

Furthermore, the third information item can be formed by a grid consisting of line-shaped and/or point-shaped elements. Particularly preferably, the line-shaped and/or point-shaped elements of the grid of the third information item are arranged offset from the line-shaped and/or point-shaped elements of the grid of the first information item and/or have a different line thickness or a different point diameter.

According to a further preferred embodiment, to further increase the protection from forgery a second foil is applied at least to the region of the verification element where the diffractive structures are located. Said second foil covers the diffractive structures, so that it is no longer possible for a forger to cast the otherwise exposed diffractive structures. The second foil is preferably fastened, for example bonded or welded, at its edge with the verification element, and additionally fastened on the peaks of the diffractive structures within the area of the verification element. As a result it is advantageously achieved that the second foil cannot be detached from the verification element without destroying the diffractive structures in case of a forgery attack.

According to a further preferred embodiment, the outline form of the partial metallization constitutes a superficial first motif which is already perceived without a display.

This invention is an extension or supplementation of the subject matter from WO 2009/019038 A1, with the subject matter and scope of protection of WO 2009/019038 A1 being incorporated into this invention in this regard. This means in particular that corresponding embodiments, examples of embodiments and concretizations of WO 2009/019038 A1 can also be used for this invention.

With reference to the following examples and supplementary figures, the advantages of the invention will be explained. The described single features and hereinafter described embodiment examples are inventive taken alone, but are also inventive in combination. The examples represent preferred embodiments, but the invention should in no way be limited thereto. The proportions shown in the figures do not correspond to the relations existing in reality and serve solely to improve the illustrative value. The representations in the figures are strongly schematized for the sake of better comprehension and do not reflect the actual conditions. In addition, the described embodiments are reduced to the essential core information for the sake of better comprehension. In actual implementation it is possible to use considerably more complex patterns or pictures in single- or multicolor printing. The information represented in the following examples can likewise be replaced by picture or text information as elaborate as desired.

The various exemplary embodiments mentioned hereinabove and hereinbelow are not restricted to employment in the described form either, but can also be combined with each other to enhance the effects.

Specifically, the schematic drawings show the following:

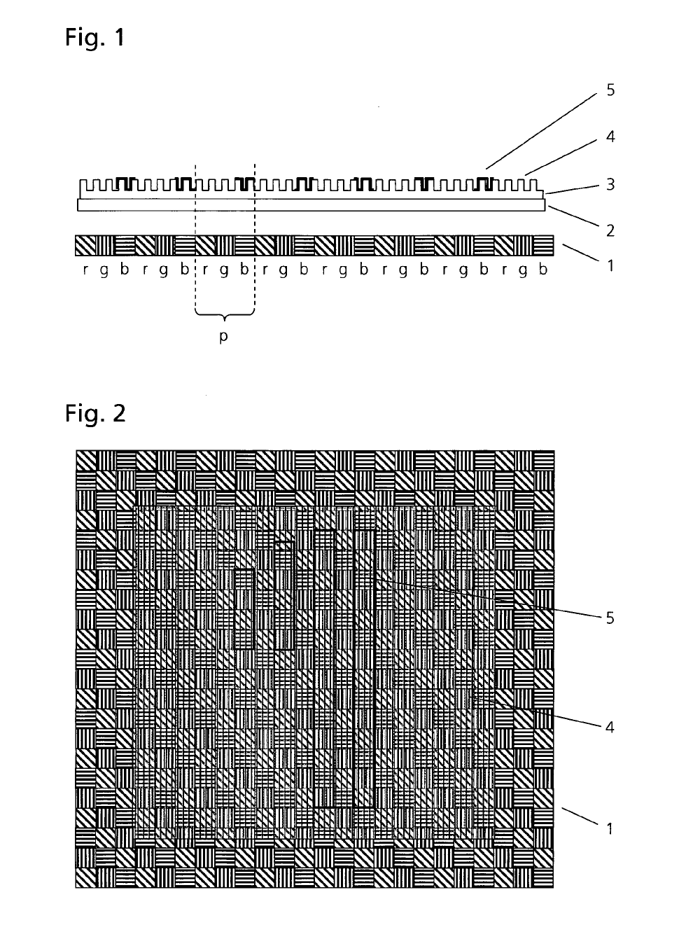

FIG. 1 a verification element according to the invention in cross section which is arranged over a display,

FIG. 2 the verification element according to the invention from FIG. 1 in plan view.

FIG. 1 shows a verification element according to the invention in cross section which is arranged over a display 1. The display 1 here is an actively luminous display which consists of an alternating arrangement of red r, green g and blue b pixels, with the arrangement of red, green and blue pixels recurring periodically with a period p.

Over the display there is applied to a transparent substrate 2 a lacquer layer 3 into which diffractive structures 4 are embossed in the form of equidistant microlines. On the surface of the diffractive structures there is located a grid consisting of elements 5 which form the first information item. The grid of the elements 5 has the same period p as the pixels of the display 1 here, so that in this example an element 5 is located over every blue pixel.

The grid of the elements 5 forms a reflective layer which consists for example of an ink with metallic or metalloid pigments or a metallic or metalloid and vapor-deposited layer. The reflective layer follows the contours of the subjacent diffractive structures, so that a surface hologram with a reflective surface arises. In the regions of the diffractive structures where the elements 5 are not applied, the verification element appears nearly transparent to a viewer. The surface hologram is thus only recognizable at the places where the elements 5 are located.

The dimension of the individual pixels of the display 1 preferably lies below the resolving power of the human eye. If all pixels have a similar or the same lightness, the display 1 appears to a viewer as a homogeneous white area. The human eye is known to have especially high sensitivity in the green spectral region during the day. If there is thus employed a display in which all pixels have the same lateral dimensions, i.e. the green pixels have the same diameter or the same width and length as the red or blue pixels, the lightness of the green pixels must be reduced relative to the lightness of the red and blue pixels, in order that all pixels or colors produce the same lightness impression for a human eye, thus resulting in the impression of a homogeneous white area. Alternatively, there can be employed a display in which different colored pixels have different lateral dimensions, i.e. for example the green pixels have a smaller area than the red and blue pixels.

FIG. 2 shows the verification element according to the invention from FIG. 1 in plan view. The outline form of the grid of the elements 5 forms here an information item in the form of the digit “1” which a viewer can perceive optically as a hologram.

1-12. (canceled)

13. A method for verifying value documents which have a substrate having at least one light-transmissive region;
wherein a first information item is arranged in at least one light-transmissive region of the substrate;
wherein there is employed a separate display which consists of a gridded arrangement of pixels;
wherein there is displayed through the separate display at least regionally a second information item which correlates with the first information item;
wherein a further information item not recognizable and/or readable to a viewer without auxiliary means is hidden in the first and/or second information item;
wherein the substrate is placed with its first information item over the second information item which is displayed on the separate display;
wherein the hidden information item becomes recognizable and/or readable;
wherein
the first information item is formed by light-transmissive diffractive structures whose surface is furnished with an at least partly reflective coating,
the at least partly reflective coating is formed from elements arranged in a gridded manner, with the gridded arrangement of said elements being adapted to the gridded arrangement of the pixels of the display.

14. The method according to claim 13, wherein the diffractive structures are formed by at least one surface-structure hologram.

15. The method according to claim 14, wherein there is applied to the substrate at least in partial regions a lacquer layer into which the diffractive structures are embossed.

16. The method according to claim 13, wherein the at least partly reflective coating is applied to the substrate over the full area at least in partial regions of the substrate, and the gridded arrangement of the elements is produced by gridded ablation of the coating.

17. The method according to claim 16, wherein the ablation of the coating is effected using a laser beam or a washing method.

18. The method according to claim 13, wherein the at least partly reflective coating is applied to the substrate in a gridded manner at least in partial regions of the substrate.

19. The method according to claim 13, wherein the at least partly reflective coating is imprinted or vapor-deposited.

20. The method according to claim 19, wherein the at least partly reflective coating is formed by an ink containing metallic or metalloid pigments.

21. The method according to claim 13, wherein the first information item has at least a third information item contained therein.

22. A method for verifying or testing objects of value having a display which consists of a gridded arrangement of pixels;
wherein there is provided a separate verification element which has at least one substrate having at least one light-transmissive region, wherein a first information item is arranged in at least one light-transmissive region of the substrate;
wherein there is displayed through the display at least regionally a second information item which correlates with the first information item;
wherein a further information item not recognizable and/or readable to a viewer without auxiliary means is hidden in the first and/or second information item;
wherein the substrate is placed with its first information item over the second information item which is displayed on the display;
wherein the hidden information item becomes recognizable and/or readable;
wherein
the first information item is formed by light-transmissive diffractive structures whose surface is furnished with an at least partly reflective coating;
the at least partly reflective coating is formed from elements arranged in a gridded manner, with the gridded arrangement of said elements being adapted to the gridded arrangement of the pixels of the display.

23. The method according to claim 22, wherein the diffractive structures are formed by at least one surface-structure hologram.

24. The method according to claim 23, wherein there is applied to the substrate at least in partial regions a lacquer layer into which the diffractive structures are embossed.

25. The method according to claim 22, wherein the at least partly reflective coating is applied to the substrate over the full area at least in partial regions of the substrate, and the gridded arrangement of the elements is produced by gridded ablation of the coating.

26. The method according to claim 25, wherein the ablation of the coating is effected using a laser beam or a washing method.

27. The method according to claim 22, wherein the at least partly reflective coating is applied to the substrate in a gridded manner at least in partial regions of the substrate.

28. The method according to claim 22, wherein the at least partly reflective coating is imprinted or vapor-deposited.

29. The method according to claim 28, wherein the at least partly reflective coating is formed by an ink containing metallic or metalloid pigments.

30. The method according to claim 22, wherein the first information item has at least a third information item contained therein.

31. An apparatus for carrying out the method according to claim 13, wherein the display is a screen of a computer, of a notebook or of a laptop, a monitor of a cash register of a cash-register system, or a display of a hand-held unit.

32. An apparatus for carrying out the method according to claim 22, wherein the object of value having a display is a computer, a notebook or a laptop, a cash register of a cash-register system, or a hand-held unit.
